(19) United States
(12) Patent Application Publication
(10) Pub. No.: US 2012/0141909 A1
(43) Pub. Date: Jun. 7, 2012

(54) MEMBRANE ELECTRODE ASSEMBLIES AND HIGHLY DURABLE FUEL CELLS

(76) Inventors: Oemer Uensal, Mainz (DE); Thomas Schmidt, Frankfurt (DE); Jörg Belack, Mainz (DE)

(21) Appl. No.: 13/349,613

(22) Filed: Jan. 13, 2012

Related U.S. Application Data
(62) Division of application No. 11/572,323, filed on Feb. 20, 2007, now abandoned.

(30) Foreign Application Priority Data
Jul. 21, 2004 (DE) 102004035305.0

(51) Int. Cl. H01M 8/10

(52) U.S. Cl. 429/482

(57) ABSTRACT

The invention relates to a membrane electrode assembly which comprises two gas diffusion layers, each contacted with a catalyst layer, which are separated by a polymer-electrolyte membrane. Said polymer electrolyte membrane has an inner area which is contacted with a catalyst layer, and an outer area which is not provided on the surface of a gas diffusion layer. The inventive assembly is characterized in that the thickness of all components of the outer area is 50 to 100%, based on the thickness of all components of the inner area. The thickness of the outer area decreases over a period of 5 hours by not more than 5% at a temperature of 80° C. and a pressure of 5 N/mm². The decrease in thickness is determined after a first compression step which takes place over a period of 1 minute at a pressure of 5 N/mm².

The present invention relates to improved membrane electrode assemblies and highly durable fuel cells, comprising two electrochemically active electrodes which are separated by a polymer electrolyte membrane.

Nowadays, as proton-conducting membranes in polymer electrolyte membrane (PEM) fuel cells, sulphonic acid-modified polymers are almost exclusively employed. Here, predominantly perfluorinated polymers are used. Nation™ from DuPont de Nemours, Wilmington, USA is a prominent example of this. For the conduction of protons, a relatively high water content is required in the membrane which typically amounts to 4-20 molecules of water per sulphonic acid group. The required water content, but also the stability of the polymer in connection with acidic water and the reaction gases hydrogen and oxygen, restricts the operating temperature of the PEM fuel cell stack to 80-100° C. Higher operating temperatures cannot be implemented without a decrease in performance of the fuel cell. At temperatures higher than the dew point of water for a given pressure level, the membrane dries out completely and the fuel cell provides no more electric power as the resistance of the membrane increases to such high values that an appreciable current flow no longer occurs.

A membrane electrode assembly with integrated gasket based on the technology set forth above is described, for example, in U.S. Pat. No. 5,464,700. Here, in the outer area of the membrane electrode assembly, films made of elastomers are provided on the surfaces of the membrane that are not covered by the electrode which simultaneously constitute the gasket to the bipolar plates and the outer space.

By means of this measure, savings on very expensive membrane material can be achieved. Further advantages that may be obtained by means of this structure relate to the contamination of the membrane. An improvement of the long-term stability is not demonstrated in U.S. Pat. No. 5,464,700. This is also due to the very low operating temperatures. In the description of the invention set forth in U.S. Pat. No. 5,464,700, it is indicated that the operating temperature of the cell is limited to a temperature of up to 80° C. Elastomers are usually also only suitable for long-term service temperatures of up to 100° C. It is not possible to achieve higher working temperatures with elastomers. Therefore, the method described herein is not suitable for fuel cells with operating temperatures of more than 100° C.

Due to system-specific reasons, however, operating temperatures in the fuel cell of more than 100° C. are desirable. The activity of the catalysts based on noble metals and contained in the membrane electrode assembly (MEA) is significantly improved at high operating temperatures.

Especially when the so-called reformates from hydrocarbons are used, the reformer gas contains considerable amounts of carbon monoxide which usually have to be removed by means of an elaborate gas conditioning or gas purification process. The tolerance of the catalysts to the CO impurities is increased at high operating temperatures.

Furthermore, heat is produced during operation of fuel cells. However, cooling of these systems to less than 80° C. can be very complex. Depending on the power output, the cooling devices can be constructed significantly less complex. This means that the waste heat in fuel cell systems that are operated at temperatures of more than 100° C. can be utilised distinctly better and therefore the efficiency of the fuel cell system can be increased.

To achieve these temperatures, in general, membranes with new conductivity mechanisms are used. One approach to this end is the use of membranes which show ionic conductivity without employing water. The first promising development in this direction is set forth in the document WO96/13872.

In this document, there is also described a first method for producing membrane electrode assemblies. To this end, two electrodes are pressed onto the membrane, each of which only covers part of the two main surfaces of the membrane. A PTFE gasket is pressed onto the remaining exposed part of the main surfaces of the membrane in the cell such that the gas spaces of anode and cathode are sealed in respect to each other and the environment. However, it was found that a membrane electrode assembly produced in such a way only exhibits high durability with very small cell surface areas of 1 cm². If bigger cells, in particular with a surface area of at least 10 cm², are produced, the durability of the cells at temperatures of more than 150° C. is limited to less than 100 hours.

Another high-temperature fuel cell is disclosed in document JP-A-2001-1960982. In this document, an electrode membrane unit is presented which is provided with a polyimide gasket. However, the problem with this structure is, that for sealing two membranes are required between which a seal ring made of polyimide is provided. As the thickness of the membrane has to be chosen as little as possible due to technical reasons, the thickness of the seal ring between the two membranes described in JP-A-2001-196082 is extremely restricted. It was found in long-term tests that such a structure is likewise not stable over a period of more than 1000 hours.

Furthermore, a membrane electrode assembly is known from DE 10235360 which contains polyimide layers for sealing. However, these layers have a uniform thickness such that the boundary area is thinner than the area which is in contact with the membrane.

The membrane electrode assemblies mentioned above are generally connected with planar bipolar plates which include channels for a flow of gas milled into the plates. As part of the membrane electrode assemblies has a higher thickness than the gaskets described above, a gasket is inserted between the gasket of the membrane electrode assemblies and the bipolar plates which is usually made of PTFE.

It was now found that the service life of the fuel cells described above is limited.

Therefore, it is an object of the present invention to provide an improved MEA and the fuel cells operated therewith which preferably should have the following properties:
The cells should exhibit a long service life during operation at temperatures of more than 100° C.
The individual cells should exhibit a consistent or improved performance at temperatures of more than 100° C. over a long period of time.
In this connection, the fuel cells should have a high open circuit voltage as well as a low gas crossover after a long operating time.
It should be possible to employ the fuel cells in particular at operating temperatures of more than 100° C. and without additional fuel gas humidification. The membrane electrode assemblies should in particular be able to resist permanent or alternating pressure differences between anode and cathode.
Furthermore, it was consequently an object of the present invention to make available a membrane electrode assembly which can be produced in an easy way and inexpensive.
In particular, the fuel cell should have, even after a long period of time, a high voltage and it should be possible to operate it with a low stoichiometry.
In particular, the MEA should be robust to different operating conditions (T, p, geometry, etc.) to increase the reliability in general.

These objects are solved through membrane electrode assemblies with all the features of claim 1.

Accordingly, the object of the present invention is a membrane electrode assembly which comprises two gas diffusion layers, each contacted with a catalyst layer, which are separated by a polymer electrolyte membrane, wherein the polymer electrolyte membrane has an inner area which is contacted with a catalyst layer, and an outer area which is not provided on the surface of a gas diffusion layer, characterized in that the thickness of all components of the outer area is 50 to 100%, based on the thickness of all components of the inner area, wherein the thickness of the outer area decreases over a period of 5 hours by not more than 5% at a temperature of 80° C. and a pressure of 5 N/mm², wherein this decrease in thickness is determined after a first compression step which takes place over a period of 1 minute at a pressure of 5 N/mm².

### Polymer Electrolyte Membranes

For the purposes of the present invention, suitable polymer electrolyte membranes are known per se. In general, membranes containing polymers comprising phosphonic acid groups which are obtainable via polymerisation of monomers comprising phosphonic acid groups are used for this purpose.

Such polymer membranes can be obtained, amongst other possibilities, by a process comprising the steps of
A) preparation of a composition comprising monomers comprising phosphonic acid groups,
B) applying a layer using the composition in accordance with step A) to a support,
C) polymerisation of the monomers comprising phosphonic acid groups present in the flat structure obtainable in accordance with step B).

Monomers comprising phosphonic acid groups are known in professional circles. These are compounds having at least one carbon-carbon double bond and at least one phosphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the scope of the present invention, the polymer comprising phosphonic acid groups results from the polymerisation product which is obtained by polymerisation of the monomer comprising phosphonic acid groups alone or with further monomers and/or cross-linking agents.

The monomer comprising phosphonic acid groups can comprise one, two, three or more carbon-carbon double bonds. Furthermore, the monomer comprising phosphonic acid groups can contain one, two, three or more phosphonic acid groups.

Generally, the monomer comprising phosphonic acid groups contains 2 to 20, preferably 2 to 10, carbon atoms.

The monomer comprising phosphonic acid groups used in step A) is preferably a compound of the formula

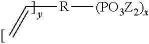

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, for example ethyleneoxy group, or a C5-C20 aryl or heteroaryl group wherein the above-mentioned radicals themselves can be substituted with halogen, —OH, —CN, and x represents an integer 1, 2, 3, 4, 5, 6, 7, 8, 9 or 10, y represents an integer 1, 2, 3, 4, 5, 6, 7, 8, 9 or 10, and/or of the formula

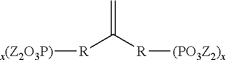

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10
and/or of the formula

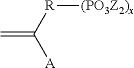

wherein
A represents a group of the formulae COOR², CN, CONR²₂, OR² and/or R², wherein R² represents hydrogen, a C1-C15 alkyl group, a C1-C15 alkoxy group, for example ethyleneoxy group, or a C5-C20 aryl or heteroaryl group wherein the above-mentioned radicals themselves can be substituted with halogen, —OH, COOZ, —CN, NZ₂
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10.

Preferred monomers comprising phosphonic acid groups include, amongst others, alkenes having phosphonic acid groups, such as ethenephosphonic acid, propenephosphonic acid, butenephosphonic acid; acrylic acid and/or methacrylic acid compounds having phosphonic acid groups, such as for example 2-phosphonomethyl acrylic acid, 2-phosphonomethyl methacrylic acid, 2-phosphonomethyl acrylamide and 2-phosphonomethyl methacrylamide.

Commercially available vinylphosphonic acid (ethenephosphonic acid), such as it is available from the company Aldrich or Clariant GmbH, for example, is particularly preferably used. A preferred vinylphosphonic acid has a purity of more than 70%, in particular 90% and particularly preferably a purity of more than 97%.

The monomers comprising phosphonic acid groups can furthermore be employed in the form of derivatives which subsequently can be converted to the acid wherein the conversion to the acid can also take place in the polymerised state. These derivatives include in particular the salts, the esters, the amides and the halides of the monomers comprising phosphonic acid groups.

The composition produced in step A) preferably comprises at least 20% by weight, in particular at least 30% by weight and particularly preferably at least 50% by weight, based on the total weight of the composition, of monomers comprising phosphonic acid groups.

The composition produced in step A) can additionally contain further organic and/or inorganic solvents. The organic solvents include in particular polar aprotic solvents, such as dimethyl sulphoxide (DMSO), esters, such as ethyl acetate, and polar protic solvents, such as alcohols, such as ethanol, propanol, isopropanol and/or butanol. The inorganic solvents include in particular water, phosphoric acid and polyphosphoric acid.

These can affect the processibility in a positive way. In particular, the solubility of polymers which are formed, for example, in step B) can be improved by the addition of the organic solvent. The content of monomers comprising phosphonic acid groups in such solutions is generally at least 5% by weight, preferably at least 10% by weight, particularly preferably between 10 and 97% by weight.

According to a particular aspect of the present invention, compositions containing monomers comprising sulphonic acid groups can be used to produce the polymers comprising phosphonic acid groups and/or ionomers comprising phosphonic acid groups.

Monomers comprising sulphonic acid groups are known in professional circles. These are compounds having at least one carbon-carbon double bond and at least one sulphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the scope of the present invention, the polymer comprising sulphonic acid groups results from the polymerisation product which is obtained by polymerisation of the monomer comprising sulphonic acid groups alone or with further monomers and/or cross-linking agents.

The monomer comprising sulphonic acid groups can comprise one, two, three or more carbon-carbon double bonds. Furthermore, the monomer comprising sulphonic acid groups can contain one, two, three or more sulphonic acid groups.

Generally, the monomer comprising sulphonic acid groups contains 2 to 20, preferably 2 to 10, carbon atoms.

The monomer comprising sulphonic acid groups is preferably a compound of the formula

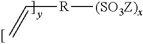

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of one another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10
y represents an integer 1, 2, 3, 4, 5, 6, 7, 8, 9 or 10
and/or of the formula

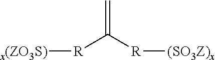

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10
and/or of the formula

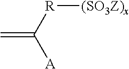

wherein
A represents a group of the formulae COOR², CN, CONR²₂, OR² and/or R², wherein R² represents hydrogen, a C1-C15 alkyl group, a C1-C15 alkoxy group, for example ethyleneoxy group, or a C5-C20 aryl or heteroaryl group wherein the above-mentioned radicals themselves can be substituted with halogen, —OH, COOZ, —CN, NZ₂
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10.

Preferred monomers comprising sulphonic acid groups include, amongst others, alkenes having sulphonic acid groups, such as ethenesulphonic acid, propenesulphonic acid, butenesulphonic acid; acrylic acid and/or methacrylic acid compounds having sulphonic acid groups, such as for example 2-sulphonomethyl acrylic acid, 2-sulphonomethyl methacrylic acid, 2-sulphonomethyl acrylamide and 2-sulphonomethyl methacrylamide.

Commercially available vinylsulphonic acid (ethenesulphonic acid), such as it is available from the company Aldrich or Clariant GmbH, for example, is particularly preferably used. A preferred vinylsulphonic acid has a purity of more than 70%, in particular 90% and particularly preferably a purity of more than 97%.

The monomers comprising sulphonic acid groups can furthermore be employed in the form of derivatives which subsequently can be converted to the acid wherein the conversion to the acid may also take place in the polymerised state. These derivatives include in particular the salts, the esters, the amides and the halides of the monomers comprising sulphonic acid groups.

According to a particular aspect of the present invention, the weight ratio of monomers comprising sulphonic acid groups to monomers comprising phosphonic acid groups can be in the range of from 100:1 to 1:100, preferably 10:1 to 1:10 and particularly preferably 2:1 to 1:2.

In another embodiment of the invention, monomers capable of cross-linking can be employed in the production of the polymer membrane. These monomers can be added to the composition in accordance with step A). Additionally, the monomers capable of cross-linking can also be applied to the flat structure in accordance with step C).

The monomers capable of cross-linking are in particular compounds having at least 2 carbon-carbon double bonds. Preference is given to dienes, trienes, tetraenes, dimethylacrylates, trimethylacrylates, tetramethylacrylates, diacrylates, triacrylates, tetraacrylates.

Particular preference is given to dienes, trienes, tetraenes of the formula

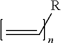

dimethylacrylates, trimethylacrylates, tetramethylacrylates of the formula

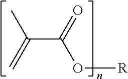

diacrylates, triacrylates, tetraacrylates of the formula

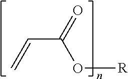

wherein
R represents a C1-C15 alkyl group, a C5-C20 aryl or heteroaryl group, NR′, —SO₂, PR′, Si(R′)₂, wherein the above-mentioned radicals themselves can be substituted,
R′ represent, independently of another, hydrogen, a C1-C15 alkyl group, a C1-C15 alkoxy group, a C5-C20 aryl or heteroaryl group, and
n is at least 2.

The substituents of the above-mentioned radical R are preferably halogen, hydroxyl, carboxy, carboxyl, carboxylester, nitriles, amines, silyl, siloxane radicals.

Particularly preferred cross-linking agents are allylmethacrylate, ethylene glycol dimethylacrylate, diethylene glycol dimethacrylate, triethylene glycol dimethylacrylate, tetraethylene and polyethylene glycol dimethacrylate, 1,3-butanediol dimethacrylate, glycerol dimethacrylate, diurethane dimethacrylate, trimethylpropane trimethacrylate, epoxy acrylates, for example Ebacryl, N′,N-methylene bisacrylamide, carbinol, butadiene, isoprene, chloroprene, divinylbenzene and/or bisphenol A dimethylacrylate. These compounds are commercially available from Sartomer Company Exton, Pa. under the designations CN-120, CN104 and CN-980, for example.

The use of cross-linking agents is optional wherein these compounds can typically be employed in the range of from 0.05 and 30% by weight, preferably 0.1 to 20% by weight, particularly preferably 1 to 10% by weight, based on the weight of the monomers comprising phosphonic acid groups.

Additionally to the polymers comprising phosphonic acid groups, the polymer membranes of the present invention can comprise further polymers (B) which cannot be obtained by polymerisation of monomers comprising phosphonic acid groups.

To this end, a further polymer (B) can be added to the composition created in step A), for example. This polymer (B) may be present in dissolved, dispersed or suspended form, amongst other things.

Preferred polymers (B) include, amongst others, polyolefines, such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinyl amine, poly(N-vinyl acetamide), polyvinyl imidazole, polyvinyl carbazole, polyvinyl pyrrolidone, polyvinyl pyridine, polyvinyl chloride, polyvinylidene chloride, polytetrafluoroethylene, polyvinyl difluoride, polyhexafluoropropylene, polyethylenetetrafluoroethylene, copolymers of PTFE with hexafluoropropylene, with perfluoropropylvinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornenes; polymers having C—O bonds in the backbone, for example polyacetal, polyoxymethylene, polyether, polypropylene oxide, polyepichlorohydrin, polytetrahydrofuran, polyphenylene oxide, polyether ketone, polyether ether ketone, polyether ketone ketone, polyether ether ketone ketone, polyether ketone ether ketone ketone, polyester, in particular polyhydroxyacetic acid, polyethyleneterephthalate, polybutyleneterephthalate, polyhydroxybenzoate, polyhydroxypropionic acid, polypropionic acid, polypivalolacton, polycaprolacton, furan resins, phenol/aryl resins, polymalonic acid, polycarbonate;

polymeric C—S bonds in the backbone, for example polysulphide ether, polyphenylenesulphide, polyethersulphone, polysulphone, polyetherethersulphone, polyarylethersulphone, polyphenylenesulphone, polyphenylenesulphidesulphone, poly(phenylsulphide)-1,4-phenylene;

polymeric C—N bonds in the backbone, for example polyimines, polyisocyanides, polyetherimine, polyetherimides, poly(trifluoromethylbis(phthalimide)phenyl, polyaniline, polyaramides, polyamides, polyhydrazides, polyurethanes, polyimides, polyazoles, polyazoles, polyazole ether ketone, polyureas, polyazines; in particular Vectra as well as

inorganic polymers, such as polysilanes, polycarbosilanes, polysiloxanes, polysilicic acid, polysilicates, silicons, polyphosphazenes and polythiazyl. These polymers can be used individually or as a mixture of two, three or more polymers.

Particular preference is given to polymers containing at least one nitrogen atom, oxygen atom and/or sulphur atom in a repeating unit. Particularly preferred are polymers containing at least one aromatic ring with at least one nitrogen, oxygen and/or sulphur heteroatom per repeating unit. From this group, polymers based on polyazoles are particularly preferred. These basic polyazole polymers contain at least one aromatic ring with at least one nitrogen heteroatom per repeating unit.

The aromatic ring is preferably a five- to six-membered ring with one to three nitrogen atoms which can be fused to another ring, in particular another aromatic ring.

In this connection, polyazoles are particularly preferred. Polymers based on polyazole generally contain recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

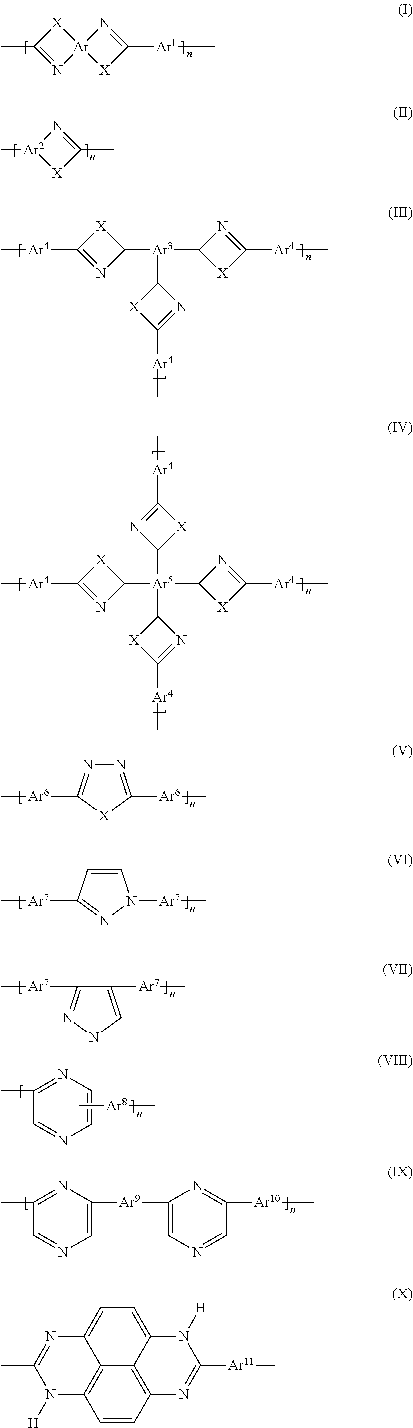

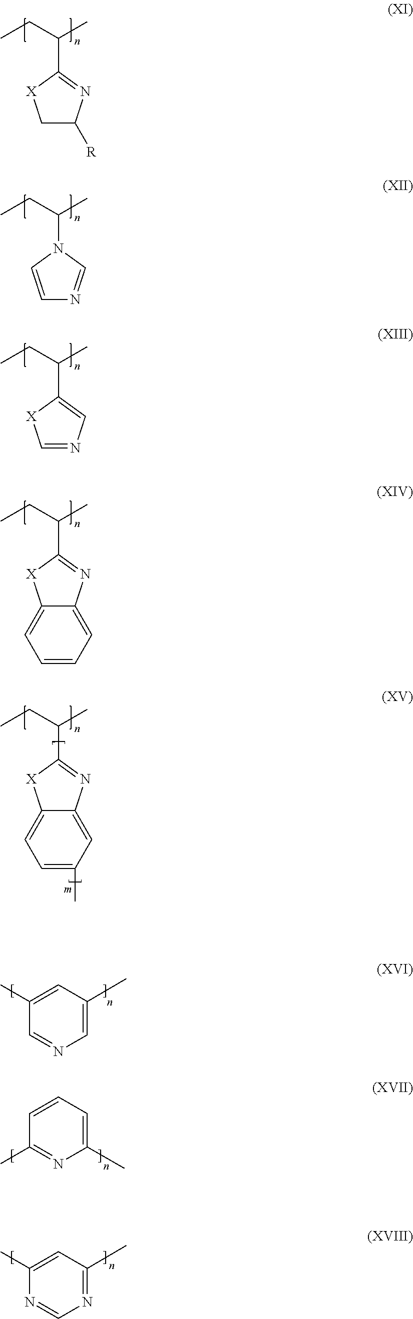

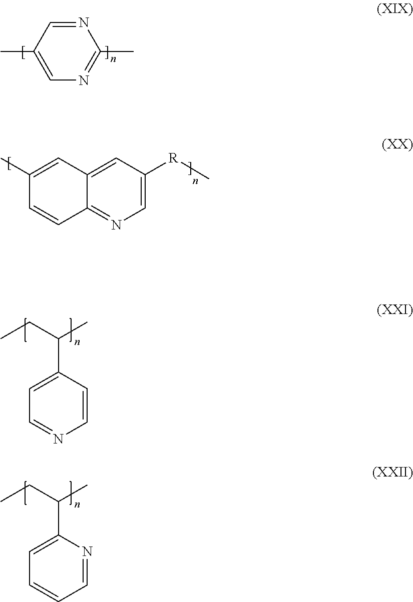

wherein
Ar are identical or different and represent a tetracovalent aromatic or heteroaromatic group which can be mononuclear or polynuclear,
Ar¹ are identical or different and represent a bicovalent aromatic or heteroaromatic group which can be mononuclear or polynuclear,
Ar² are identical or different and represent a bicovalent or tricovalent aromatic or heteroaromatic group which can be mononuclear or polynuclear,
Ar³ are identical or different and represent a tricovalent aromatic or heteroaromatic group which can be mononuclear or polynuclear,
Ar⁴ are identical or different and represent a tricovalent aromatic or heteroaromatic group which can be mononuclear or polynuclear,
Ar⁵ are identical or different and represent a tetracovalent aromatic or heteroaromatic group which can be mononuclear or polynuclear,
Ar⁶ are identical or different and represent a bicovalent aromatic or heteroaromatic group which can be mononuclear or polynuclear,
Ar⁷ are identical or different and represent a bicovalent aromatic or heteroaromatic group which can be mononuclear or polynuclear,
Ar⁸ are identical or different and represent a tricovalent aromatic or heteroaromatic group which can be mononuclear or polynuclear,
Ar⁹ are identical or different and represent a bicovalent or tricovalent or tetracovalent aromatic or heteroaromatic group which can be mononuclear or polynuclear,
Ar¹⁰ are identical or different and represent a bicovalent or tricovalent aromatic or heteroaromatic group which can be mononuclear or polynuclear,
Ar¹¹ are identical or different and represent a bicovalent aromatic or heteroaromatic group which can be mononuclear or polynuclear,
X are identical or different and represent oxygen, sulphur or an amino group which carries a hydrogen atom, a group having 1-20 carbon atoms, preferably a branched or unbranched alkyl or alkoxy group, or an aryl group as a further radical,
R represent, identical or different, hydrogen, an alkyl group and an aromatic group, represents, identical or different, hydrogen, an alkyl group and an aromatic group, with the proviso that R in the formula XX is a divalent group, and
n, m are each an integer greater than or equal to 10, preferably greater or equal to 100.

Preferred aromatic or heteroaromatic groups are derived from benzene, naphthalene, biphenyl, diphenyl ether, diphenylmethane, diphenyldimethylmethane, bisphenone, diphenylsulphone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzooxadiazole, benzopyridine, benzopyrazine, benzopyrazidine, benzopyrimidine, benzotriazine, indolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

In this case, Ar¹, Ar⁴, Ar⁶, Ar⁷, Ar⁸, Ar⁹, Ar¹⁰, Ar¹¹ can have any substitution pattern, in the case of phenylene, for example, Ar¹, Ar⁴, Ar⁶, Ar⁷, Ar⁸, Ar⁹, Ar¹⁰, Ar¹¹ can be ortho-, meta- and para-phenylene. Particularly preferred groups are derived from benzene and biphenylene which optionally also can be substituted.

Preferred alkyl groups are short-chain alkyl groups having 1 to 4 carbon atoms, e.g. methyl, ethyl, n- or i-propyl and t-butyl groups.

Preferred aromatic groups are phenyl or naphthyl groups. The alkyl groups and the aromatic groups can be substituted.

Preferred substituents are halogen atoms, e.g. fluorine, amino groups, hydroxy groups or short-chain alkyl groups, e.g. methyl or ethyl groups.

Polyazoles having recurring units of the formula (I) are preferred wherein the radicals X within one recurring unit are identical.

The polyazoles can in principle also have different recurring units wherein their radicals X are different, for example. It is preferable, however, that a recurring unit has only identical radicals X.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In another embodiment of the present invention, the polymer containing recurring azole units is a copolymer or a blend which contains at least two units of the formulae (I) to (XXII) which differ from one another. The polymers can be in the form of block copolymers (diblock, triblock), random copolymers, periodic copolymers and/or alternating polymers.

In a particularly preferred embodiment of the present invention, the polymer containing recurring azole units is a polyazole which only contains units of the formulae (I) and/or (II).

The number of recurring azole units in the polymer is preferably an integer greater than or equal to 10. Particularly preferred polymers contain at least 100 recurring azole units.

Within the scope of the present invention, polymers containing recurring benzimidazole units are preferred. Some examples of the most appropriate polymers containing recurring benzimidazole units are represented by the following formulae:

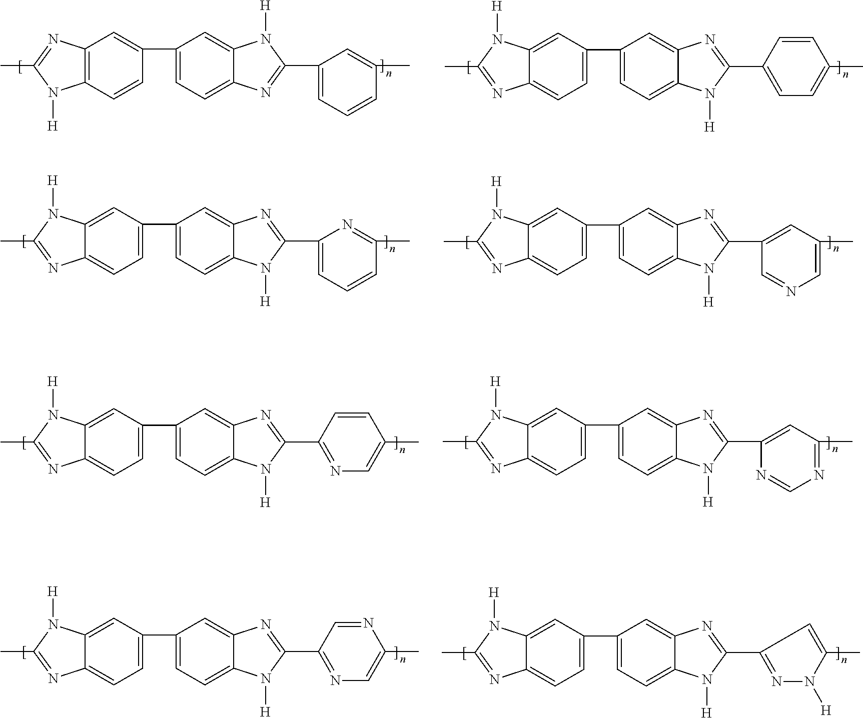

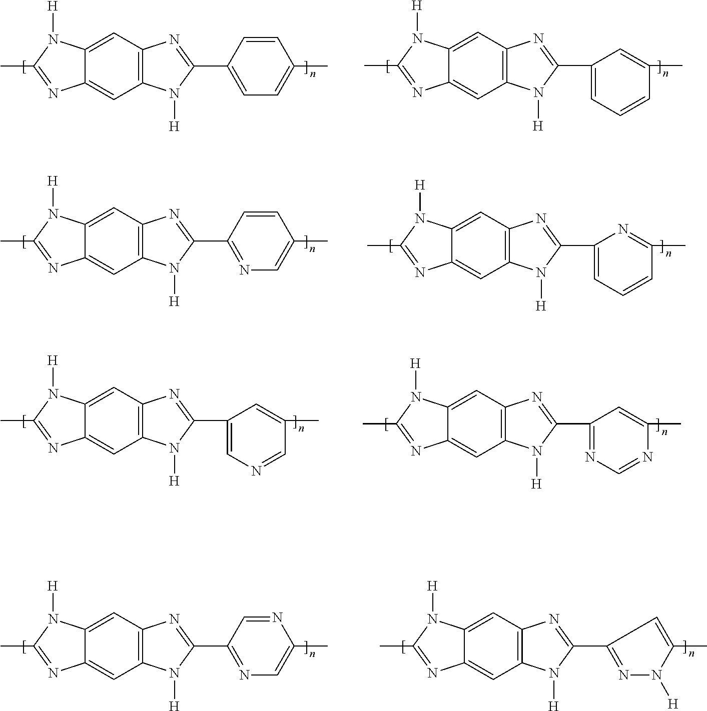

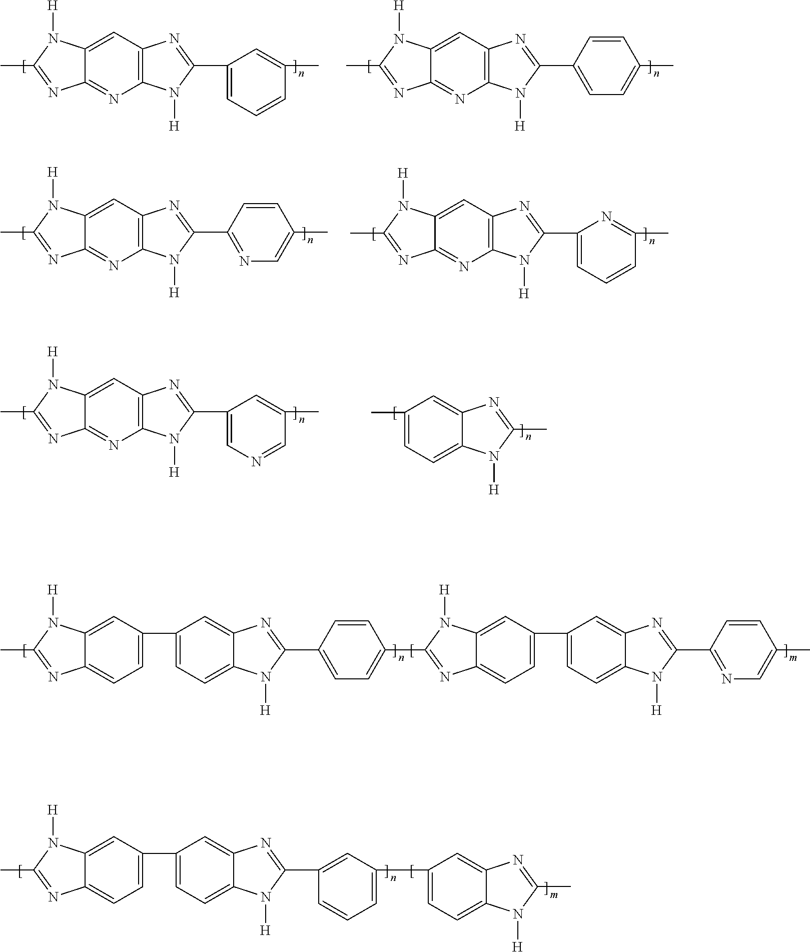

wherein n and m are each an integer greater than or equal to 10, preferably greater than or equal to 100.

Further preferred polyazole polymers are polyimidazoles, polybenzimidazole ether ketone, polybenzothiazoles, polybenzoxazoles, polytriazoles, polyoxadiazoles, polythiadiazoles, polypyrazoles, polyquinoxalines, poly(pyridines), poly(pyrimidines) and poly(tetrazapyrenes).

Preferred polyazoles are characterized by a high molecular weight. This applies in particular to the polybenzimidazoles. Measured as the intrinsic viscosity, this is preferably at least 0.2 dl/g, preferably 0.7 to 10 dl/g, in particular 0.8 to 5 dl/g.

Celazole from the company Celanese is particularly preferred. The properties of polymer film and polymer membrane can be improved by screening the starting polymer, as described in German patent application No. 10129458.1.

Furthermore, polymers with aromatic sulphonic acid groups can be used as polymer (B). Aromatic sulphonic acid groups are groups in which the sulphonic acid groups (—SO₃H) are bound covalently to an aromatic or heteroaromatic group. The aromatic group can be part of the backbone of the polymer or part of a side group wherein polymers having aromatic groups in the backbone are preferred. In many cases, the sulphonic acid groups can also be employed in the form of their salts. Furthermore, derivatives, for example esters, in particular methyl or ethyl esters, or halides of the sulphonic acids can be used which are converted to the sulphonic acid during operation of the membrane.

The polymers modified with sulphonic acid groups preferably have a content of sulphonic acid groups in the range of from 0.5 to 3 meq/g, preferably 0.5 to 2.5. This value is determined through the so-called ion exchange capacity (IEC).

To measure the IEC, the sulphonic acid groups are converted to the free acid. To this end, the polymer is treated with acid in the known manner, with excess acid being removed by washing. Thus, the sulphonated polymer is initially treated for 2 hours in boiling water. Subsequently, excess water is dabbed off and the sample is dried at 160° C. in a vacuum drying cabinet at p<1 mbar for 15 hours. Then, the dry weight of the membrane is determined. The polymer thus dried is then dissolved in DMSO at 80° C. for 1 h. Subsequently, the solution is titrated with 0.1M NaOH. The ion exchange capacity (IEC) is then calculated from the consumption of acid to reach the equivalence point and from the dry weight.

Polymers with sulphonic acid groups covalently bound to aromatic groups are known in professional circles. Polymers with aromatic sulphonic acid groups can, for example, be produced by sulphonation of polymers. Processes for the sulphonation of polymers are described in F. Kucera et al., Polymer Engineering and Science 1988, Vol. 38, No. 5, 783-792. In this connection, the sulphonation conditions can be chosen such that a low degree of sulphonation develops (DE-A-19959289).

With regard to polymers having aromatic sulphonic acid groups whose aromatic radicals are part of the side group, particular reference shall be made to polystyrene derivatives. The document U.S. Pat. No. 6,110,616 for instance describes copolymers of butadiene and styrene and their subsequent sulphonation for use in fuel cells.

Furthermore, such polymers can also be obtained by polyreactions of monomers which comprise acid groups. Thus, perfluorinated polymers as described in U.S. Pat. No. 5,422,411 can be produced by copolymerisation of trifluorostyrene and sulphonyl-modified trifluorostyrene.

According to a particular aspect of the present invention, thermoplastics stable at high temperatures which include sulphonic acid groups bound to aromatic groups are employed. In general, such polymers have aromatic groups in the backbone.

Thus, sulphonated polyether ketones (DE-A-4219077, WO96/01177), sulphonated polysulphones (J. Membr. Sci. 83 (1993), p. 211) or sulphonated polyphenylenesulphide (DE-A-19527435) are preferred.

The polymers set forth above which have sulphonic acid groups bound to aromatic groups can be used individually or as a mixture wherein mixtures having polymers with aromatic groups in the backbone are particularly preferred.

Preferred polymers include polysulphones, in particular polysulphone having aromatic groups in the backbone. According to a particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured in accordance with ISO 1133.

According to a particular aspect of the present invention, the weight ratio of polymers with sulphonic acid groups covalently bound to aromatic groups to monomers comprising phosphonic acid groups can be in the range of from 0.1 to 50, preferably from 0.2 to 20, particularly from 1 to 10.

Preferred polymers include polysulphones, in particular polysulphone having aromatic and/or heteroaromatic groups in the backbone. According to a particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured in accordance with ISO 1133. In this connection, polysulphones with a Vicat softening point VST/N50 of from 180° C. to 230° C. are preferred. In yet another preferred embodiment of the present invention, the number average of the molecular weight of the polysulphones is greater than 30,000 g/mol.

The polymers based on polysulphone include in particular polymers having recurring units with linking sulphone groups according to the general formulae A, B, C, D, E, F and/or G:

—O—R—SO₂—R— (A)

—O—R—SO₂—R—O—R— (B)

—O—R—SO₂—R—O—R— (C)

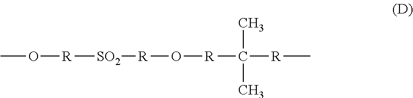

—O—R—SO₂—R—R—SO₂—R— (E)

—O—R—SO₂—R—R—SO₂—R—SO₂—] (F)

O—R—SO₂—RSO₂—R—R (G)

wherein the radicals R, independently of another, identical or different, represent aromatic or heteroaromatic groups, these radicals having been explained in detail above. These include in particular 1,2-phenylene, 1,3-phenylene, 1,4-phenylene, 4,4′-biphenyl, pyridine, quinoline, naphthalene, phenanthrene.

The polysulphones preferred within the scope of the present invention include homopolymers and copolymers, for example random copolymers. Particularly preferred polysulphones comprise recurring units of the formulae H to N:

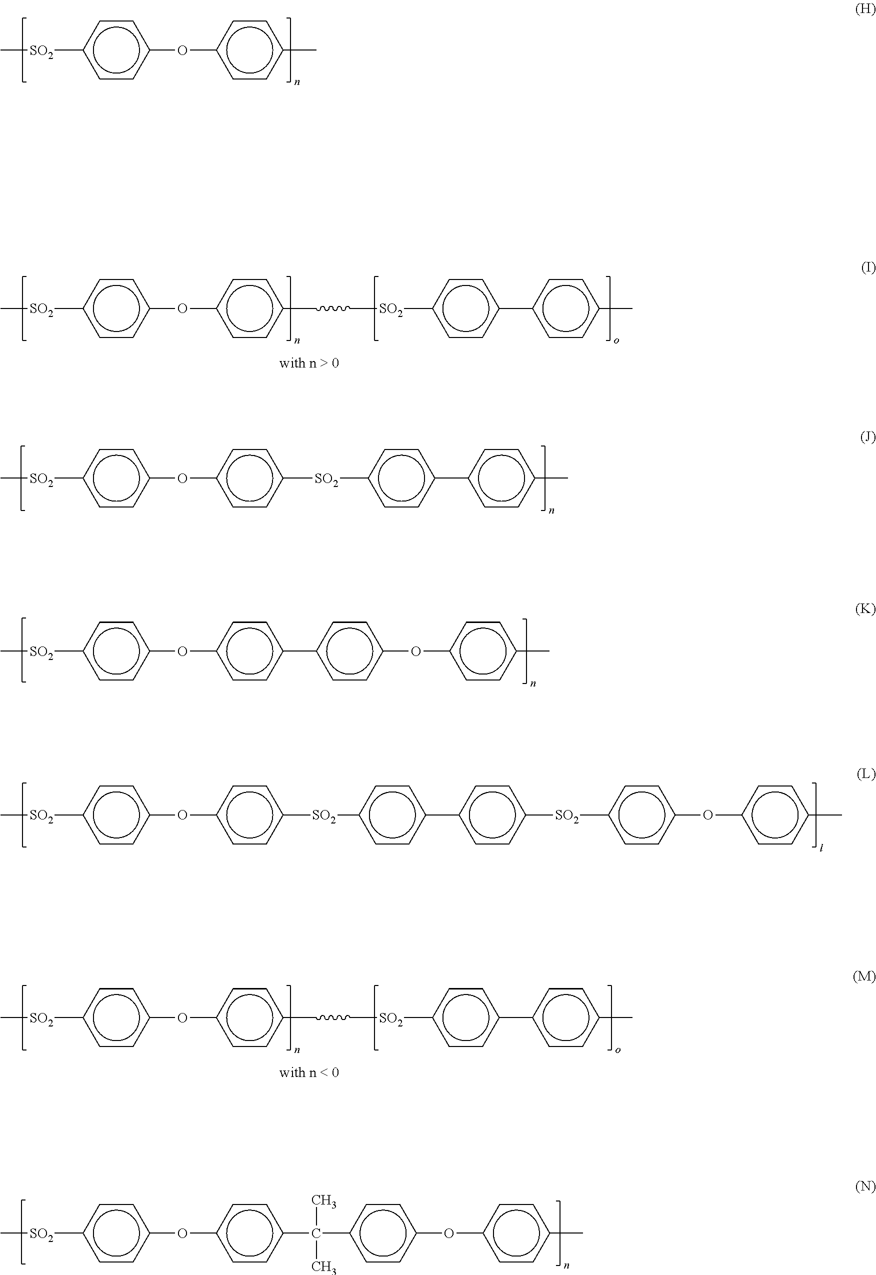

The polysulphones described above can be obtained commercially under the trade names ®Victrex 200 P, ®Victrex 720 P, ®Ultrason E, ®Ultrason S, ®Mindel, ®Radel A, ®Radel R, ®Victrex HTA, ®Astrel and ®Udel.

Furthermore, polyether ketones, polyether ketone ketones, polyether ether ketones, polyether ether ketone ketones and polyaryl ketones are particularly preferred. These high-performance polymers are known per se and can be obtained commercially under the trade names Victrex® PEEK™, ®Hostatec, ®Kadel.

According to a particular aspect of the present invention, preferred proton-conducting polymer membranes can be obtained by a process comprising the steps of
I) swelling of a polymer film with a liquid containing monomers comprising phosphonic acid groups, and
II) polymerisation of at least part of the monomers comprising phosphonic acid groups which were introduced into the polymer film in step I).

Swelling is understood to mean an increase in weight of the film by at least 3% by weight. Preferably, the swelling is at least 5%, particularly preferably at least 10%.

The determination of swelling Q is determined gravimetrically from the mass of the film before swelling, m0 and the mass of the film after polymerisation in accordance with step B, m₂.

Q=(m₂−m₀)/m_{0—×100}

The swelling preferably takes place at a temperature of more than 0° C., in particular between room temperature (20° C.) and 180° C., in a liquid which preferably contains at least 5% by weight of monomers comprising phosphonic acid groups. Furthermore, the swelling can also be performed at increased pressure. In this connection, the limitations arise from economic considerations and technical possibilities.

The polymer film used for swelling generally has a thickness in the range of from 5 to 3000 μm, preferably 10 to 1500 μm and particularly preferably 20 to 500 μm. The production of such films made of polymers is generally known, a part of these being commercially available.

The liquid containing monomers comprising phosphonic acid groups can be a solution wherein the liquid can also contain suspended and/or dispersed components. The viscosity of the liquid containing monomers comprising phosphonic acid groups can be within wide ranges wherein an addition of solvents or an increase of the temperature can take place to adjust the viscosity. Preferably, the dynamic viscosity is in the range of from 0.1 to 10000 mPa*s, in particular 0.2 to 2000 mPa*s, wherein these values can be measured in accordance with DIN 53015, for example.

The composition produced in step A) or the liquid used in step I) can additionally contain further organic and/or inorganic solvents. The organic solvents include in particular polar aprotic solvents, such as dimethyl sulphoxide (DMSO), esters, such as ethyl acetate, and polar protic solvents, such as alcohols, such as ethanol, propanol, Isopropanol and/or butanol. The inorganic solvents include in particular water, phosphoric acid and polyphosphoric acid. These can affect the processibility in a positive way. For example, the rheology of the solution can be improved such that this can be more easily extruded or applied with a doctor blade.

To further improve the properties in terms of application technology, fillers, in particular proton-conducting fillers, and additional acids can additionally be added to the membrane. Such substances preferably have an intrinsic conductivity of at least 10⁻⁶ S/cm, in particular 10⁻⁵ S/cm at 100° C. The addition can be performed in step A) and/or step B) or step I), for example. Furthermore, these additives can also be added after the polymerisation in accordance with step C) or step II), if they are in the form of a liquid.

Non-limiting examples of proton-conducting fillers are sulphates such as: CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,
Phosphates such as Zr₃(PO₄)₄, Zr(HPO₄)₂, HZr₂(PO₄)₃, UO₂PO₄.3H₂O, H₈UO₂PO₄, Ce(HPO₄)₂, Ti(HPO₄)₂, KH₂PO₄, NaH₂PO₄, LiH₂PO₄, NH₄H₂PO₄, CsH₂PO₄, CaHPO₄, MgHPO₄, HSbP₂O₈, HSb₃P₂O₁₄, H₅Sb₅P₂O₂₀,
polyacids such as H₃PW₁₂O₄₀.nH₂O (n=21-29), H₃SiWi₂O₄₀.nH₂O (n=21-29), HxWO₃, HSbWO₆, H₃PMo₁₂O₄₀, H₂Sb₄O₁₁, HTaWO₆, HNbO₃, HTiNbO₅, HtiTaO₅, HSbTeO₆, H₅Ti₄O₉, HSbO₃, H₂MoO₄
selenites and arsenites such as (NH₄)₃H(SeO₄)₂, UO₂AsO₄, (NH₄)₃H(SeO₄)₂, KH₂AsO₄, Cs₃H(SeO₄)₂, Rb₃H(SeO₄)₂,
phosphides ZrP, TiP, HfP
oxides such as Al₂O₃, Sb₂O₅, ThO₂, SnO₂, ZrO₂, MoO₃
silicates such as zeolites, zeolites(NH₄+), phyllosilicates, tectosilicates, H-natrolites, H-mordenites, NH₄-analcines, NH₄-sodalites, NH₄-gallates, H-montmorillonites
acids such as HClO₄, SbF₅
fillers such as carbides, in particular SiC, Si₃N₄, fibres, in particular glass fibres, glass powders and/or polymer fibres, preferably based on polyazoles.

These additives can be included in the proton-conducting polymer membrane in usual amounts, however, the positive properties of the membrane, such as great conductivity, long service life and high mechanical stability should not be affected too much by the addition of too large amounts of additives. Generally, the membrane comprises not more than 80% by weight, preferably not more than 50% by weight and particularly preferably not more than 20% by weight, of additives after the polymerisation in accordance with step C) or step II).

As a further component, this membrane can also contain perfluorinated sulphonic acid additives (in particular 0.1-20 wt-%, preferably 0.2-15 wt-%, especially preferably 0.2-10 wt-%). These additives result in an improvement in performance, to an increase in oxygen solubility and oxygen diffusion in the vicinity of the cathode and to a reduction in adsorption of the electrolyte on the catalyst surface. (Electrolyte additives for phosphoric acid fuel cells. Gang, Xiao; Hjuler, H. A.; Olsen, C.; Berg, R. W.; Bjerrum, N. J. Chem. Dep. A, Tech. Univ. Denmark, Lyngby, Den. J. Electrochem. Soc. (1993), 140(4), 896-902 and Perfluorosulfonimide as an additive in phosphoric acid fuel cell. Razaq, M.; Razaq, A.; Yeager, E.; DesMarteau, Darryl D.; Singh, S. Case Cent. Electrochem. Sci., Case West. Reserve Univ., Cleveland, Ohio, USA. J. Electrochem. Soc. (1989), 136(2), 385-90.)

Non-limiting examples of perfluorinated sulphonic acid additives are: trifluoromethanesulphonic acid, potassium trifluoromethanesulphonate,

sodium trifluoromethanesulphonate, lithium trifluoromethanesuiphonate, ammonium trifluoromethanesuiphonate, potassium perfluorohexanesulphonate, sodium perfluorohexanesulphonate, lithium perfluorohexanesulphonate, ammonium perfluorohexanesulphonate, perfluorohexanesulphonic acid, potassium nonafluorobutanesulphonate, sodium nonafluorobutanesulphonate, lithium nonafluorobutanesulphonate, ammonium nonafluorobutanesulphonate, cesium nonafluorobutanesulphonate, triethylammonium perfluorohexasulphonate and perfiurosulphoimides.

The formation of the flat structure in accordance with step B) is performed by means of measures known per se (pouring, spraying, application with a doctor blade, extrusion) which are known from the prior art of polymer film production. Every support that is considered as inert under the conditions is suitable as a support. These supports include in particular films made of polyethylene terephthalate (PET), polytetrafluoroethylene (PTFE), polyhexafluoropropylene, copolymers of PTFE with hexafluoropropylene, polyimides, polyphenylenesulphides (PPS) and polypropylene (PP).

The thickness of the flat structure in accordance with step B) is preferably between 10 and 4000 μm, preferably between 15 and 3500 μm, in particular between 20 and 3000 μm, particularly preferably between 30 and 1500 μm and very particularly preferably between 50 and 500 μm.

The polymerisation of the monomers comprising phosphonic acid groups in step C) or step II) is preferably a free-radical polymerisation. The formation of radicals can take place thermally, photochemically, chemically and/or electrochemically.

For example, a starter solution containing at least one substance capable of forming radicals can be added to the composition after heating of the composition in accordance with step A). Furthermore, a starter solution can be applied to the flat structure obtained in accordance with step B). This can be performed by means of measures known per se (e.g., spraying, immersing) which are known from the prior art. During production of the membrane through swelling, a starter solution can be added to the liquid. This can also be applied to the flat structure after swelling.

Suitable radical formers are, amongst others, azo compounds, peroxy compounds, persulphate compounds or azoamidines. Non-limiting examples are dibenzoyl peroxide, dicumene peroxide, cumene hydroperoxide, diisopropyl peroxydicarbonate, bis-(4-t-butylcyclohexyl)peroxydicarbonate, dipotassium persulphate, ammonium peroxydisulphate, 2,2′-azobis-(2-methylpropionitrile) (AIBN), 2,2′-azobis(isobutyric acid amidine) hydrochloride, benzopinacol, dibenzyl derivatives, methylethylene ketone peroxide, 1,1-azobiscyclohexanecarbonitrile, methyl ethyl ketone peroxide, acetyl acetone peroxide, dilauryl peroxide, didecanoyl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butyl peroxyisopropyl carbonate, 2,5-bis-(2-ethyl hexanoylperoxy)-2,5-dimethylhexane, tert-butyl peroxy-2-ethylhexanoate, tert-butyl peroxy-3,5,5-trimethylhexanoate, tert-butyl peroxyisobutyrate, tert-butyl peroxyacetate, dicumylperoxide, 1,1-bis(tert-butyl peroxy)cyclohexane, 1,1-bis(tert-butyl peroxy)-3,3,5-trimethyl cyclohexane, cumylhydroperoxide, tert-butyl hydroperoxide, bis-(4-tert-butyl cyclohexyl)peroxydicarbonate, as well as the radical formers available from the company DuPont under the name ®Vazo, for example ®Vazo V50 and ®Vazo WS.

Furthermore, it is also possible to employ radical formers which form radicals with irradiation Preferred compounds include, amongst others, α,α-diethoxyacetophenone (DEAP, Upjon Corp), n-butyl benzoin ether (®Trigonal-14, AKZO) and 2,2-dimethoxy-2-phenylacetophenone (®Igacure 651) and 1-benzoyl cyclohexanol (®Igacure 184), bis-(2,4,6-trimethylbenzoyl)phenylphosphine oxide (®Irgacure 819) and 1-[4-(2-hydroxyethoxy)phenyl]-2-hydroxy-2-phenylpropan-1-one (®Irgacure 2959)

Typically, between 0.0001 and 5% by weight, in particular 0.01 to 3% by weight (based on the weight of the monomers comprising phosphonic acid groups) of radical formers are added. The amount of radical former can be varied according to the degree of polymerisation desired.

The polymerisation can also take place by action of IR or NIR (IR=infrared, i.e. light having a wavelength of more than 700 nm; NIR=near-IR, i.e. light having a wavelength in the range of from about 700 to 2000 nm and an energy in the range of from about 0.6 to 1.75 eV), respectively.

The polymerisation can also take place by action of UV light having a wavelength of less than 400 nm. This polymerisation method is known per se and described, for example, in Hans Joerg Elias, Makromolekulare Chemie, 5th edition, volume 1, pp. 492-511; D. R. Arnold, N. C. Baird, J. R. Bolton, J. C. D. Brand, P. W. M Jacobs, P. de Mayo, W. R. Ware, Photochemistry—An Introduction, Academic Press, New York and M. K. Mishra, Radical Photopolymerization of Vinyl Monomers, J. Macromol. Sci.—Revs. Macromol. Chem. Phys. C22 (1982-1983) 409.

The polymerisation can also be effected by action of β-, γ- and/or electron rays. According to a particular embodiment of the present invention, a membrane is irradiated with a radiation dose in the range of from 1 to 300 kGy, preferably from 3 to 250 kGy and very particularly preferably from 20 to 200 kGy.

The polymerisation of the monomers comprising phosphonic acid groups in step C) or step II) preferably takes place at temperatures of more than room temperature (20° C.) and less than 200° C., in particular at temperatures between 40° C. and 150° C., particularly preferably between 50° C. and 120° C. The polymerisation is preferably performed at normal pressure, but can also be carried out with action of pressure. The polymerisation leads to a solidification of the flat structure wherein this solidification can be observed via measuring the microhardness. Preferably, the increase in hardness caused by the polymerisation is at least 20%, based on the hardness of the flat structure obtained in step B).

According to a particular embodiment of the present invention, the membranes exhibit a high mechanical stability. This variable results from the hardness of the membrane which is determined via microhardness measurement in accordance with DIN 50539. To this end, the membrane is successively loaded over 20 s with a Vickers diamond up to a force of 3 mN and the depth of indentation is determined. According to this, the hardness at room temperature is at least 0.01 N/mm², preferably at least 0.1 N/mm² and very particularly preferably at least 1 N/mm²; however, this should not constitute a limitation. Subsequently, the force is kept constant at 3 mN over 5 s and the creep of the depth of penetration is calculated. In preferred membranes, the creep CHU 0.003/20/5 under these conditions is less than 20%, preferably less than 10% and very particularly preferably less than 5%. The modulus determined by microhardness measurement, YHU is at least 0.5 MPa, in particular at least 5 MPa and very particularly preferably at least 10 MPa; however, this should not constitute a limitation.

The hardness of the membrane relates to both a surface which does not have a catalyst layer and a face that has a catalyst layer.

Depending on the degree of polymerisation desired, the flat structure which is obtained after polymerisation is a self-supporting membrane. Preferably, the degree of polymerisation is at least 2, in particular at least 5, particularly preferably at least 30, repeating units, in particular at least 50 repeating units, very particularly preferably at least 100 repeating units. This degree of polymerisation is defined by the number average of the molecular weight Mn which can be determined by GPC methods. Due to the problems of isolating the polymers comprising phosphonic acid groups contained in the membrane without degradation, this value is determined by means of a sample which is obtained by polymerisation of monomers comprising phosphonic acid groups without addition of polymer. In this connection, the weight proportion of monomers comprising phosphonic acid groups and of radical starters in comparison to the ratios of the production of the membrane is kept constant. The conversion obtained with a comparative polymerisation is preferably greater than or equal to 20%, in particular greater than or equal to 40% and particularly preferably greater than or equal to 75%, based on the monomers comprising phosphonic acid groups employed.

The polymers comprising phosphonic acid groups contained in the membrane preferably have a wide molecular weight distribution. Thus, the polymers comprising phosphonic acid groups can have a polydispersity M_{w}/Mₙ in the range of from 1 to 20, particularly preferably from 3 to 10.

The water content of the proton-conducting membrane is preferably not more than 15% by weight, particularly preferably not more than 10% by weight and very particularly preferably not more than 5% by weight.

In this connection, it can be assumed that the conductivity of the membrane may be based on the Grotthus mechanism whereby the system does not require any additional humidification. Preferred membranes accordingly comprise proportions of low molecular weight polymers comprising phosphonic acid groups. Thus, the proportion of polymers comprising phosphonic acid groups with a degree of polymerisation in the range of from 2 to 20 can preferably be at least 10% by weight, particularly preferably at least 20% by weight, based on the weight of the polymers comprising phosphonic acid groups.

The polymerisation in step C) or step II) can lead to a reduction in layer thickness. Preferably, the thickness of the self-supporting membrane is between 15 and 1000 μm, preferably between 20 and 500 μm, in particular between 30 and 250 μm.

Preferably, the membrane obtained in accordance with step C) or step II) is self-supporting, i.e. it can be detached from the support without any damage and then directly processed further, if applicable.

Following the polymerisation in accordance with step C) or step II), the membrane can be cross-linked thermally, photochemically, chemically and/or electrochemically on the surface. This hardening of the membrane surface further improves the properties of the membrane.

According to a particular aspect, the membrane can be heated to a temperature of at least 150° C., preferably at least 200° C. and particularly preferably at least 250° C. Preferably, the thermal cross-linking takes place in the presence of oxygen. In this process step, the oxygen concentration usually is in the range of from 5 to 50% by volume, preferably 10 to 40% by volume; however, this should not constitute a limitation.

The cross-linking can also take place by action of IR or NIR (IR=infrared, i.e. light having a wavelength of more than 700 nm; NIR=near-IR, i.e. light having a wavelength in the range of from about 700 to 2000 nm and an energy in the range of from about 0.6 to 1.75 eV), respectively, and/or UV light. Another method is irradiation with β-, γ- and/or electron rays. In this connection, the radiation dose is preferably between 5 and 250 kGy, in particular 10 to 200 kGy. The irradiation can take place in the open air or under inert gas. Through this, the usage properties of the membrane, in particular its durability, are improved.

Depending on the degree of cross-linking desired, the duration of the cross-linking reaction can be within a wide range. Generally, this reaction time is in the range of from 1 second to 10 hours, preferably 1 minute to 1 hour; however, this should not constitute a limitation.

According to a particular embodiment of the present invention, the membrane comprises, according to an elemental analysis, at least 3% by weight, preferably at least 5% by weight and particularly preferably at least 7% by weight, of phosphorus, based on the total weight of the membrane. The proportion of phosphorus can be determined by elemental analysis. To this end, the membrane is dried at 110° C. for 3 hours under vacuum (1 mbar).

The polymers comprising phosphonic acid groups preferably have a content of phosphonic acid groups of at least 5 meq/g, particularly preferably at least 10 meq/g. This value is determined through the so-called ion exchange capacity (IEC).

To measure the IEC, the phosphonic acid groups are converted to the free acid, the measurement being performed before polymerisation of the monomers comprising phosphonic acid groups. Subsequently, the sample is titrated with 0.1 M NaOH. The ion exchange capacity (IEC) is then calculated from the consumption of acid to reach the equivalence point and from the dry weight.

The polymer membrane according to the invention has improved material properties compared to the doped polymer membranes previously known. In particular, they exhibit better performances in comparison with known doped polymer membranes. The reason for this is in particular improved proton conductivity. This is at least 1 mS/cm, preferably at least 2 mS/cm, in particular at least 5 mS/cm at temperatures of 120° C.

Furthermore, the membranes also exhibit a higher conductivity at a temperature of 70° C. The conductivity depends, amongst other things, on the content of sulphonic acid groups of the membrane. The higher this proportion, the better is the conductivity at low temperatures. In this connection, a membrane according to the invention can be humidified at low temperatures. To this end, the compound used as energy source, for example hydrogen, may be provided with a proportion of water. In many cases, however, the water formed by the reaction is sufficient to achieve a humidification.

The specific conductivity is measured by means of impedance spectroscopy in a 4-pole arrangement in potentiostatic mode and using platinum electrodes (wire, 0.25 mm diameter). The distance between the current-collecting electrodes is 2 cm. The spectrum obtained is evaluated using a simple model comprised of a parallel arrangement of an ohmic resistance and a capacitor. The cross section of the sample of the phosphoric-acid-doped membrane is measured immediately prior to mounting of the sample. To measure the temperature dependency, the measurement cell is brought to the desired temperature in an oven and regulated using a Pt-100 thermocouple arranged in the immediate vicinity of the specimen. Once the temperature is reached, the specimen is held at this temperature for 10 minutes prior to the start of measurement.

### Gas Diffusion Layer

The membrane electrode assembly according to the invention has two gas diffusion layers which are separated by the polymer electrolyte membrane. Flat, electrically conductive and acid-resistant structures are commonly used for this. These include, for example, graphite-fibre paper, carbon-fibre paper, graphite fabric and/or paper which was rendered conductive by addition of carbon black. Through these layers, a fine distribution of the flows of gas and/or liquid is achieved.

Generally, this layer has a thickness in the range of from 80 μm to 2000 μm, in particular 100 μm to 1000 μm and particularly preferably 150 μm to 500 μm.

According to a particular embodiment, at least one of the gas diffusion layers can be comprised of a compressible material. Within the scope of the present invention, a compressible material is characterized by the characteristic that the gas diffusion layer can be compressed by pressure to half, in particular a third of its original thickness without losing its integrity.

This characteristic is generally exhibited by a gas diffusion layer made of graphite fabric and/or paper which was rendered conductive by addition of carbon black.

### Catalyst Layer

The catalyst layer(s) contain(s) catalytically active substances. These include, amongst others, precious metals of the platinum group, i.e. Pt, Pd, Ir, Rh, Os, Ru, or also the precious metals Au and Ag. Furthermore, alloys of the above-mentioned metals may also be used. Additionally, at least one catalyst layer can contain alloys of the elements of the platinum group with non-precious metals, such as for example Fe, Co, Ni, Cr, Mn, Zr, Ti, Ga, V, etc. Furthermore, the oxides of the above-mentioned precious metals and/or non-precious metals can also be employed.

The catalytically active particles comprising the above-mentioned substances may be employed as metal powder, so-called black precious metal, in particular platinum and/or platinum alloys. Such particles generally have a size in the range of from 5 nm to 200 nm, preferably in the range of from 7 nm to 100 nm.

Furthermore, the metals can also be employed on a support material. Preferably, this support comprises carbon which particularly may be used in the form of carbon black, graphite or graphitised carbon black. Furthermore, electrically conductive metal oxides, such as for example, SnOₓ, TiOₓ, or phosphates, e.g. FePOₓ, NbPOₓ, Zr_{y}(POₓ)_{z}, can be used as support material. In this connection, the indices x, y and z designate the oxygen or metal content of the individual compounds which can lie within a known range as the transition metals can be in different oxidation stages.

The content of these metal particles on a support, based on the total weight of the metal-support-bond, is generally in the range of from 1 to 80% by weight, preferably 5 to 60% by weight and particularly preferably 10 to 50% by weight; however, this should not constitute a limitation. The particle size of the support, in particular the size of the carbon particles, is preferably in the range of from 20 to 1000 nm, in particular 30 to 100 nm. The size of the metal particles present thereon is preferably in the range of from 1 to 20 nm, in particular 1 to 10 nm and particularly preferably 2 to 6 nm.

The sizes of the different particles represent mean values and can be determined via transmission electron microscopy or X-ray powder diffractometry.

The catalytically active particles set forth above can generally be obtained commercially.

Furthermore, the catalytically active layer may contain customary additives. These include, amongst others, fluoropolymers, such as e.g. polytetrafluoroethylene (PTFE), proton-conducting ionomers and surface-active substances.

According to a particular embodiment of the present invention, the weight ratio of fluoropolymer to catalyst material comprising at least one precious metal and optionally one or more support materials is greater than 0.1, this ratio preferably lying within the range of from 0.2 to 0.6.

According to a particular embodiment of the present invention, the catalyst layer has a thickness in the range of from 1 to 1000 μm, in particular from 5 to 500, preferably from 10 to 300 μm. This value represents a mean value which can be determined by averaging the measurements of the layer thickness from photographs that can be obtained with a scanning electron microscope (SEM).

According to a particular embodiment of the present invention, the content of precious metals of the catalyst layer is 0.1 to 10.0 mg/cm², preferably 0.3 to 6.0 mg/cm² and particularly preferably 0.3 to 3.0 mg/cm². These values can be determined by elemental analysis of a flat specimen.

For further information on membrane electrode assemblies, reference is made to the technical literature, in particular the patent applications WO 01/18894 A2, DE 195 09 748, DE 195 09 749, WO 00/26982, WO 92/15121 and DE 197 57 492. The disclosure contained in the above-mentioned citations with respect to the structure and production of membrane electrode assemblies as well as the electrodes, gas diffusion layers and catalysts to be chosen is also part of the description.

The electrochemically active surface of the catalyst layer defines the surface which is in contact with the polymer electrolyte membrane and at which the redox reactions set forth above can take place. The present invention allows for the formation of particularly large electrochemically active surfaces. According to a particular aspect of the present invention, the size of this electrochemically active surface is at least 2 cm², in particular at least 5 cm² and preferably at least 10 cm²; however, this should not constitute a limitation. The term electrode means that the material exhibits electron conductivity, the electrode defining the electrochemically active area.

The polymer electrolyte membrane has an inner area which is contacted with a catalyst layer, and an outer area which is not provided on the surface of a gas diffusion layer. In this connection, provided means that the inner area has no area overlapping with a gas diffusion layer if an inspection perpendicular to the surface of a gas diffusion layer or of the outer area of the polymer electrolyte membrane is carried out, such that, only after contacting the polymer electrolyte membrane with the gas diffusion layer, an allocation can be made.

The outer area of the polymer electrolyte membrane can have a monolayer structure. In this case, the outer area of the polymer electrolyte membrane generally consists of the same material as the inner area of the polymer electrolyte membrane.

Furthermore, the outer area of the polymer electrolyte membrane can comprise in particular at least one more layer, preferably at least two more layers. In this case, the outer area of the polymer electrolyte membrane has at least two or at least three components.

The thickness of all components of the outer area of the polymer electrolyte membrane is greater than the thickness of the inner area of the polymer electrolyte membrane. The thickness of the outer area relates to the sum of the thicknesses of all components of the outer area. The components of the outer area result from the vector parallel to the surface area of the outer area of the polymer electrolyte membrane, wherein the layers that this vector intersects are to be added to the components of the outer area.

The outer area preferably has a thickness in the range of from 80 μm to 4000 μm, in particular in the range of from 120 μm to 2000 μm and particularly preferably in the range of from 150 μm to 800 μm.

The thickness of all components of the outer area is 50% to 100%, preferably 65% to 95% and particularly preferably 75% to 85%, based on the sum of the thicknesses of all components of the inner area. In this connection, the thickness of the components of the outer area relates to the thickness these components have after a first compression step which is performed at a pressure of 5 N/mm², preferably 10 N/mm² over a period of 1 minute. The thickness of the components of the inner area relates to the thicknesses of the layers employed, without a compression step being necessary in this connection.

The thickness of all components of the inner area results in general from the sum of the thicknesses of the membrane, the catalyst layers and the gas diffusion layers of the anode and cathode.

The thickness of the layers is determined with a digital thickness tester from the company Mitutoyo. The initial pressure of the two circular flat contact surfaces during measurement is 1 PSI, the diameter of the contact surface is 1 cm.

The catalyst layer is in general not self-supporting but is usually applied to the gas diffusion layer and/or the membrane. In this connection, part of the catalyst layer can, for example, diffuse into the gas diffusion layer and/or the membrane, resulting in the formation of transition layers. This can also lead to the catalyst layer being understood as part of the gas diffusion layer. The thickness of the catalyst layer results from measuring the thickness of the layer onto which the catalyst layer was applied, for example the gas diffusion layer or the membrane, the measurement providing the sum of the catalyst layer and the corresponding layer, for example the sum of the gas diffusion layer and the catalyst layer.

The thickness of the components of the outer area decreases over a period of 5 hours by not more than 5% at a temperature of 80° C. and a pressure of 5 N/mm², wherein this decrease in thickness is determined after a first compression step which takes place over a period of 1 minute at a pressure of 5 N/mm², preferably 10 N/mm².

The measurement of the pressure- and temperature-dependent deformation parallel to the surface vector of the components of the outer area, in particular the outer area of the polymer electrolyte membrane, is performed with a hydraulic press with heatable press plates.

In this connection, the hydraulic press exhibits the following technical data:

The press has a force range of 50-50000 N with a maximum compression area of 220×220 mm². The resolution of the pressure sensor is ±1 N.

An inductive distance sensor with a measuring range of 10 mm is attached to the press plates. The resolution of the distance sensor is ±1 μm.

The press plates can be operated in a temperature range of from RT−200° C.

The press is operated in a force-controlled mode by means of a PC with corresponding software.

The data of the force and distance sensor are recorded and depicted in real time at a data rate of up to 100 measured data/second.

Testing method:

The material to be tested is cut to a surface area of 55×55 mm² and placed between the press plates preheated to 80°, 120° C. and 160° C., respectively.

The press plates are closed and an initial force of 120 N is applied such that the control circuit of the press is closed. At this point, the distance sensor is set to 0. Subsequently, a pressure ramp previously programmed is executed. To this end, the pressure is increased at a rate of 2 N/mm²s to a predefined value, for example 5, 10, 15 or 20 N/mm², and this value is maintained for at least 5 hours. After completing the total holding time, the pressure is decreased to 0 N/mm² with a ramp of 2 N/mm²s and the press is opened.

The relative and/or absolute change in thickness can be read from a deformation curve recorded during the pressure test or can be measured following the pressure test through a measurement with a standard thickness tester.

This characteristic of the components of the outer area is generally achieved through the use of polymers having a high pressure stability. In this connection, the polymer electrolyte membrane can have a particularly high degree of cross-linking in the outer area which can be achieved by specific irradiation as has been described above.

Preferably, the outer area of the membrane is irradiated with a dose of at least 100 kGy, preferably at least 132 kGy and particularly preferably at least 200 kGy. The inner area of the membrane is preferably irradiated with a dose of not more than 130 kGy, preferably not more than 99 kGy and particularly preferably not more than 80 kGy. The ratio of irradiation power of the outer area to irradiation power of the inner area is preferably at least 1.5, particularly preferably at least 2 and very particularly preferably at least 2.5.

The irradiation of the outer area can furthermore preferably be performed with a UV lamp having a power of at least 50 W, in particular 100 W and particularly preferably 200 W. In this connection, the duration can be within a wide range. Preferably, the irradiation is carried out for at least one minute, in particular at least 30 minutes and particularly preferably at least 5 hours, in many cases an irradiation of up to 30 hours, in particular up to 10 hours being sufficient. The ratio of duration of irradiation of the outer area to duration of irradiation of the inner area is preferably at least 1.5, particularly preferably at least 2 and very particularly preferably at least 2.5.

If the outer area has a multilayer structure, these materials generally likewise exhibit high pressure stability.

Preferably, the thickness of the components of the outer area decreases over a period of 5 hours, particularly preferably 10 hours, by not more than 5%, in particular not more than 2%, preferably not more than 1%, at a temperature of 120° C., particularly preferably 160° C., and a pressure of 5 N/mm², preferably 10 N/mm², in particular 15 N/mm² and particularly preferably 20 N/mm².

According to a particular aspect of the present invention, the outer area comprises at least one, preferably at least two polymer layers having a thickness greater than or equal to 10 μm, each of the polymers of these layers having a modulus of elasticity of at least 6 N/mm², preferably at least 7 N/mm², measured at 80° C., preferably 160° C., and an elongation of 100%. Measurement of these values is carried out in accordance with DIN EN ISO 527-1.

According to a particular aspect of the present invention, a layer can be applied by thermoplastic processes, for example injection moulding or extrusion. Accordingly, a layer is preferably made of a meltable polymer.

Within the scope of the present invention, preferably used polymers preferably exhibit a long-term service temperature of at least 190° C., preferably at least 220° C. and particularly preferably at least 250° C., measured in accordance with MIL-P-46112B, paragraph 4.4.5.

Preferred meltable polymers include in particular fluoropolymers, such as for example poly(tetrafluoroethylen-co-hexafluoropropylene) FEP, polyvinylidenefluoride PVDF, perfluoroalkoxy polymer PFA, poly(tetrafluoroethylen-co-perfluoro(methylvinylether)) MFA. These polymers are in many cases commercially available, for example under the trade names Hostafon®, Hyflon®, Teflon®, Dyneon® and Nowoflon®.

One or both layers can be made of, amongst others, polyphenylenes, phenol resins, phenoxy resins, polysulphide ether, polyphenylenesulphide, polyethersulphones, polyimines, polyetherimines, polyazoles, polybenzimidazoles, polybenzoxazoles, polybenzothiazoles, polybenzoxadiazoles, polybenzotriazoles, polyphosphazenes, polyether ketones, polyketones, polyether ether ketones, polyether ketone ketones, polyphenylene amides, polyphenylene oxides, polyimides and mixtures of two or more of these polymers.

The polyimides also include polymers also containing, besides imide groups, amide (polyamideimides), ester (polyesterimides) and ether groups (polyetherimides) as components of the backbone.

The different layers can be connected with each other by use of suitable polymers. These include in particular fluoropolymers. Suitable fluoropolymers are known in professional circles. These include, amongst others, polytetrafluoroethylene (PTFE) and poly(tetrafluoroethylen-co-hexafluoropropylene) (FEP). The layer made of fluoropolymers present on the layers described above in general has a thickness of at least 0.5 μm, in particular at least 2.5 μm. This layer can be provided between the polymer electrolyte membrane and further layers. Furthermore, the layer can also be applied to the side facing away from the polymer electrolyte membrane. Additionally, both surfaces of the layers to be laminated can be provided with a layer made of fluoropolymers. Surprisingly, it is possible to improve the long-term stability of the MEAs through this.

At least one component of the outer area of the polymer electrolyte membrane is usually in contact with electrically conductive separator plates which are typically provided with flow field channels on the sides facing the gas diffusion layers to allow for the distribution of reactant fluids. The separator plates are usually manufactured of graphite or conductive, thermally stable plastic.

Interacting with the separator plates, the components of the outer area seal the gas spaces against the outside. Furthermore, interacting with the inner area of the polymer electrolyte membrane, the components of the outer area generally also seal the gas spaces between anode and cathode. Surprisingly, it was therefore found that an improved sealing concept can result in a fuel cell with a prolonged service life.

The following figures describe different embodiments of the present invention, these figures intended to deepen the understanding of the present invention; however, this should not constitute a limitation.

The figures show:

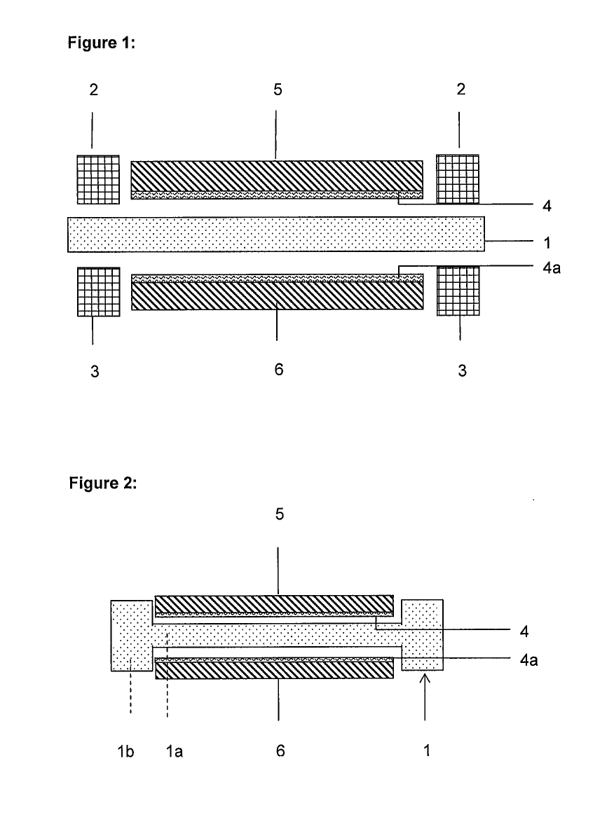

FIG. 1 a diagrammatical cross-section of a membrane electrode assembly according to the invention, the catalyst layer being applied to the gas diffusion layer,

FIG. 2 a diagrammatical cross-section of a second membrane electrode assembly according to the invention, the catalyst layer being applied to the gas diffusion layer,

FIG. 1 shows a cross-sectional side view of a membrane electrode assembly according to the invention. It is a diagram wherein the depiction describes the state before compression and the spaces between the layers are intended to improve the understanding. Here, the polymer electrolyte membrane 1 has a layer with a substantially constant thickness. The outer area is formed by two layers 2 and 3, such that the outer area has a greater thickness than the inner area of the polymer electrolyte membrane. The inner area of the polymer electrolyte membrane is in contact with the catalyst layers 4 and 4a. A gas diffusion layer 5, 6 having a catalyst layer 4 or 4a, respectively, is provided on each of the two sides of the surface of the inner area of the polymer electrolyte membrane 1. Through this, a gas diffusion layer 5 provided with a catalyst layer 4 forms the anode or the cathode, respectively, whereas the second gas diffusion layer 6 provided with a catalyst layer 4a forms the cathode or the anode, respectively. The thickness of the sum of the layers 1+2+3 is in the range of from 50 to 100%, preferably 65 to 95% and particularly preferably 75 to 85%, of the thickness of the layers 1+4+4a+5+6.

FIG. 2 shows a cross-sectional side view of a membrane electrode assembly according to the invention. It is a diagram wherein the depiction describes the state before compression and the spaces between the layers are intended to improve the understanding. Here, the polymer electrolyte membrane 1 has an inner area 1a and an outer area 1b. The inner area of the polymer electrolyte membrane is in contact with the catalyst layers 4 and 4a. A gas diffusion layer 5, 6 having a catalyst layer 4 or 4a, respectively, is provided on each of the two sides of the surface of the inner area of the polymer electrolyte membrane 1. Through this, a gas diffusion layer 5 provided with a catalyst layer 4 forms the anode or the cathode, respectively, whereas the second gas diffusion layer 6 provided with a catalyst layer 4a forms the cathode or the anode, respectively. The thickness of the outer area 1b is in the range of from 50 to 100%, preferably 65 to 95% and particularly preferably 75 to 85%, of the thickness of the layers 1a+4+4a+5+6.

The production of a membrane electrode assembly according to the invention is apparent to the person skilled in the art. Generally, the different components of the membrane electrode assembly are superposed and connected with each other by pressure and temperature. In general, lamination is carried out at a temperature in the range of from 10 to 300° C., in particular 20° C. to 200° C. and with a pressure in the range of from 1 to 1000 bar, in particular 3 to 300 bar.

The outer area of the polymer electrolyte membrane can subsequently be thickened by a second polymer layer. This second layer can be laminated on top, for example. Furthermore, the second layer can also be applied by thermoplastic processes, for example extrusion or injection moulding.

After cooling, the finished membrane electrode assembly (MEA) is operational and can be used in a fuel cell.

Particularly surprising, it was found that membrane electrode assemblies according to the invention can be stored or shipped without any problems, due to their dimensional stability at varying ambient temperatures and humidity. Even after prolonged storage or after shipping to locations with markedly different climatic conditions, the dimensions of the MEA are right to be fitted into fuel cell stacks without difficulty. In this case, the MEA need not be conditioned for an external assembly on site which simplifies the production of the fuel cell and saves time and cost.

One benefit of preferred MEAs is that they allow for the operation of the fuel cell at temperatures above 120° C. This applies to gaseous and liquid fuels, such as e.g. hydrogen-containing gases that are produced e.g. in an upstream reforming step from hydrocarbons. In this connection, e.g. oxygen or air can be used as oxidant.

Another benefit of preferred MEAs is that, during operation at more than 120° C., they have a high tolerance to carbon monoxide, even with pure platinum catalysts, i.e. without any further alloy components. At temperatures of 160° C., e.g. more than 1% CO can be contained in the fuel without this leading to a markedly reduction in performance of the fuel cell.

Preferred MEAs can be operated in fuel cells without the need to humidify the fuels and the oxidants despite the high operating temperatures possible. The fuel cell nevertheless operates in a stabile manner and the membrane does not lose its conductivity. This simplifies the entire fuel cell system and results in additional cost savings as the guidance of the water circulation is simplified. Furthermore, the behaviour of the fuel cell system at temperatures of less than 0° C. is also improved through this.

Preferred MEAs surprisingly make it possible to cool the fuel cell to room temperature and lower without difficulty and to subsequently put it back into operation without a loss in performance. Furthermore, the preferred MEAs of the present invention exhibit a very high long-term stability. It was found that a fuel cell according to the invention can be continuously operated over long periods of time, e.g. more than 5000 hours, at temperatures of more than 120° C. with dry reaction gases without it being possible to detect an appreciable degradation in performance. The power densities obtainable in this connection are very high, even after such a long period of time.

In this connection, the fuel cells according to the invention exhibit, even after a long period of time, for example more than 5000 hours, a high off-load voltage which is preferably at least 900 mV, particularly preferably at least 920 mV after this period of time. To measure the open circuit voltage, a fuel cell with a hydrogen flow on the anode and an air flow on the cathode is operated currentless. The measurement is carried out by switching the fuel cell from a current of 0.2 A/cm² to the currentless state and then recording the open circuit voltage for 2 minutes from this point onwards. The value after 5 minutes is the respective open circuit potential. The measured values of the open circuit voltage apply to a temperature of 160° C. Furthermore, the fuel cell preferably exhibits a low gas cross over after this period of time. To measure the cross over, the anode side of the fuel cell is operated with hydrogen (5 l/h), the cathode with nitrogen (5 l/h). The anode serves as the reference and counter electrode, the cathode as the working electrode. The cathode is set to a potential of 0.5 V and the hydrogen diffusing through the membrane and whose mass transfer is limited at the cathode oxidizes. The resulting current is a variable of the hydrogen permeation rate. The current is <3 mA/cm², preferably <2 mA/cm², particularly preferably <1 mA/cm² in a cell of 50 cm². The measured values of the H₂ cross over apply to a temperature of 160° C.

Furthermore, the MEAs according to the invention can be produced inexpensive and in an easy way.

For further information on membrane electrode assemblies, reference is made to the technical literature, in particular the patents U.S. Pat. No. 4,191,618, U.S. Pat. No. 4,212,714 and U.S. Pat. No. 4,333,805. The disclosure contained in the above-mentioned citations [U.S. Pat. No. 4,191,618, U.S. Pat. No. 4,212,714 and U.S. Pat. No. 4,333,805] with respect to the structure and production of membrane electrode assemblies as well as the electrodes, gas diffusion layers and catalysts to be chosen is also part of the description.

### PATENT EXAMPLE

A PBI film with a thickness of 50 μm was produced in accordance with DE 10331365.6. The film was washed three times in H₂O at 80° C. Subsequently, the film was doped with a mixture of vinylphosphonic acid:H₂O (9:1) at 50° C. The membrane was then irradiated with electron irradiation at 99 kGy. The thickness of the membrane after the irradiation was 120 μm.

The membrane thus obtained was used to produce a membrane electrode assembly. The surface area of the membrane was 80 mm*80 mm. The membrane was placed between an anode (54 mm*54 mm) and a cathode (54 mm*54 mm) and compressed to a total thickness of 720 μm at 120° C.

A diffusion layer coated with catalyst and containing ionomer was used as the anode. The catalyst load was 1.5 mgp_{Pt/RU}/cm².

A diffusion layer coated with catalyst and containing ionomer was used as the anode. The catalyst load was 4 mgp_{Pt}/cm².

The active MEA surface area is 29.26 cm² and the total surface area of the membrane is 64 cm². The thickness of the membrane in the outer area was on average 70 μm, the thickness in the outer area on average 100 μm.

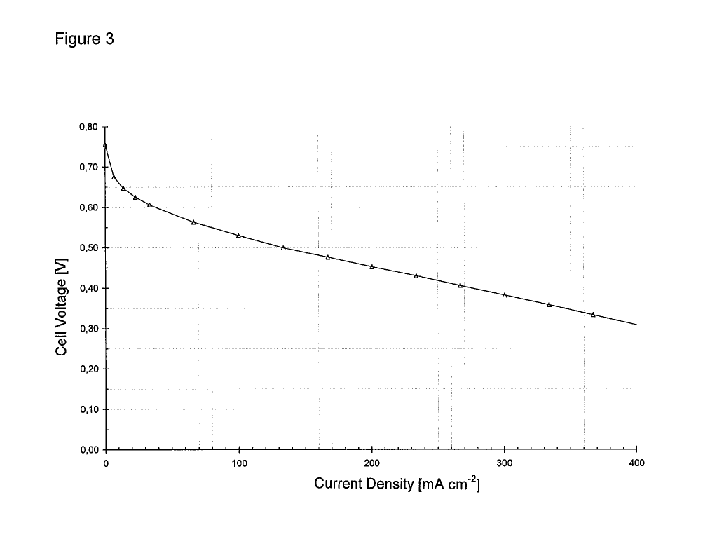

The following performance data of the MEA could be achieved which are depicted in FIG. 3:

0.5 M MeOH/air, q (MeOH)=20 ml/min, stoich. (air)=3 (min 200 ml/min), T=110° C.

The methanol cross over was 70 mA/cm² and the cell resistance 200 mOhmcm².

1-20. (canceled)

21. A precursor for a membrane electrode assembly comprising:
two gas diffusion layers;
two catalyst layers, said catalyst layers are in contact with said gas diffusion layers;
a polymer electrolyte membrane having an inner area and an outer area, a thickness of said outer area being in the range of 50-100% based on a thickness of said inner area;
said thickness of said outer area decreasing by not more than 5% over a period of 5 hours at a temperature of 80° C. and a pressure of 5 N/mm², said decreasing being determined after a first compression step, said first compression step occurring over a period of 1 minute at a pressure of 5 N/mm².

22. The precursor according to claim 21, wherein said outer area having a monolayer structure.

23. The precursor according to claim 21, wherein said outer area of said polymer electrolyte membrane further comprising at least one more layer.

24. The precursor according to claim 21 wherein said thickness of said outer area is 75 to 85%, based on said thickness of said inner area.

25. The precursor according to claim 23 wherein said outer area having at least one polymer layer which is meltable.

26. The precursor according to claim 25, wherein said polymer layer is comprised of fluoropolymers.

27. The precursor according to claim 25 wherein said polymer layer is selected from the group consisting of: polyphenylenes, phenol resins, phenoxy resins, polysuiphide ether, polyphenylenesulphide, polyethersulphones, polyimines, polyetherimines, polyazoles, polybenzimidazoles, polybenzoxazoles, polybenzothiazoles, polybenzoxadiazoles, polybenzotriazoles, polyphosphazenes, polyether ketones, polyketones, polyether ether ketones, polyether ketone ketones, polyphenylene amides, polyphenylene oxides, polyimides, or combinations thereof.

28. The precursor according to claim 21, wherein said outer area further comprising at least two polymer layers having a thickness greater than or equal to 10 μm, wherein each polymer within said polymer layers having a modulus of elasticity of at least 6 N/mm², measured at 160° C. and an elongation of 100%.

29. The precursor according to claim 21, wherein said polymer electrolyte membrane of said inner area having a thickness in the range of from 15 to 1000 μm.

30. The precursor according to claim 21, wherein said outer area having a thickness in the range of from 120 to 2000 μm.

31. The precursor according to claim 21, wherein a ratio of the thickness of said outer area of said polymer electrolyte membrane to the thickness of said inner area of said polymer electrolyte membrane is in the range of from 1:1 to 200:1.

32. The precursor according to claim 21, wherein each of the two catalyst layers having an electrochemically active surface, the size of which is at least 2 cm².

33. The precursor according to claim 21, wherein said polymer electrolyte membrane is comprised of polyazoles.

34. The precursor according to claim 21, wherein said polymer electrolyte membrane comprising polymers which can be obtained by polymerisation of monomers selected from the group consisting of: phosphonic acid groups, sulphonic acid groups, or combinations thereof.

35. The precursor according to claim 21, wherein at least one of the gas diffusion layers is made of a compressible material.

36. A fuel cell comprising at least one membrane electrode assembly made from the precursor according to claim 21.

37. The fuel cell according to claim 36, at least one of said components of said outer area is in contact with one or more electrically conductive separator plates.
